(19) United States
(12) Patent Application Publication
(10) Pub. No.: US 2019/0264748 A1
(43) Pub. Date: Aug. 29, 2019

(54) ADJUSTING DEVICE

(71) Applicant: SCHAEFFLER TECHNOLOGIES AG & CO. KG, HERZOGENAURACH (DE)

(72) Inventors: Peter ZIERER, Erlangen (DE); Juergen WEBER, Erlangen (DE)

(73) Assignee: SCHAEFFLER TECHNOLOGIES AG & CO. KG, HERZOGENAURACH (DE)

(21) Appl. No.: 16/319,977

(22) PCT Filed: Oct. 19, 2017
(86) PCT No.: PCT/DE2017/100907

§ 371 Date: Jan. 23, 2019

(30) Foreign Application Priority Data
Oct. 24, 2016 (DE) 10 2016 220 854.3

(51) Int. Cl. F16D 3/04

(52) U.S. Cl. CPC F16D 3/04

(57) ABSTRACT

An electric camshaft adjuster comprising an electric motor that includes a compensating coupling for coupling to gearing, wherein the compensating coupling includes a motor shaft configured to couple the electric motor to the gearing of the electric camshaft adjuster while enabling a radial offset, a second, gearing-side coupling element, and a compensating element that interacts with the motor shaft and the second, gearing-side coupling element,

### CROSS-REFERENCE TO RELATED APPLICATIONS

This application is the U.S. National Phase of PCT/DE2017/100907 filed Oct. 19, 2017, which claims priority to DE 102016220854.3 filed Oct. 24, 2016, the entire disclosures of which are incorporated by reference herein.

### TECHNICAL FIELD

The disclosure relates to an adjusting device that has a compensating coupling according to the disclosure below. The compensating coupling couples a motor shaft of an electric motor to a gearing, in particular a reduction gearing, for conjoint rotation therewith.

### BACKGROUND

Such an adjusting device is known, for example, from DE 10 2007 051 475 A1. An adjusting device is described therein that has a compensating coupling in the form of an Oldham coupling. The known adjusting device can be used as a phase adjuster in an internal combustion engine. An Oldham disk of the device, referred to in general as an offset compensation element, is connected to an inner ring of a rolling element bearing.

Another phase adjuster for an internal combustion engine with an Oldham coupling is known from DE 10 2007 049 072 A1. A double-winged drive element interacts with the Oldham disk, which is made of plastic in this case. The drive element can be displaced to a limited extent in a specific direction in relation to the Oldham disk. The double-winged drive element is disposed on a drive shaft of an actuator.

An Oldham coupling for connecting two shaft ends is known from DE 198 57 248 C2, wherein an Oldham disk forms a component of a tongue and groove system.

### SUMMARY

One of the fundamental objects of the disclosure is further develop an adjusting device that is more compact and easily installed than the aforementioned prior art, which has a compensating coupling that couples an electric motor to a gearing, in particular a reduction gearing.

This problem is solved according to the disclosure by an adjusting device as disclosed below. A basic concept of the adjusting device is that it has a compensating coupling, which compensates for a radial offset between the electric motor and a gearing actuated by said motor. The components of the compensating coupling comprise a first, motor-side coupling element, connected to a motor shaft of the electric motor for conjoint rotation therewith, a second, gearing-side coupling element, and a compensating element that interacts with both coupling elements. In accordance with the disclosure, the motor shaft of the electric motor also forms the first coupling element of the compensating coupling.

Compared to conventional assemblies, which comprise an electric drive, a gearing, and a compensating coupling that couples the electric drive to the gearing in a flexible manner, the number of components and the size of the assembly are significantly reduced, without any functional limitations. Furthermore, the inertia torques may be drastically reduced compared to conventional adjusting devices, contributing to a substantial improvement in the adjustment dynamics.

The compensating coupling may be an Oldham coupling. The Oldham coupling may be first installed in the final installment step in the framework of producing the adjusting device. There is no conventional Oldham disk, such as can be found in conventional compensating couplings, in the adjusting device according to this application. The function of the Oldham disk is assumed instead, in an advantageous design, by a double-winged compensating element, the outer shape of which corresponds in principle to a double-winged drive element in an adjusting device. In particular, the outer shape of the compensating element can correspond to the outer shape of the drive element indicated by the reference numeral 18 in the aforementioned DE 10 2007 049 072 A1, which is also referred to as a “drive element.” The fundamental difference to the device known from DE 10 2007 049 072 A1 is that the double-winged element used in the adjusting device according to the application is not connected to either of the shafts or other rotating components that are to be coupled to one another for conjoint rotation therewith.

The double-winged compensating element can be displaced in two orthogonal, radial directions to a limited extent in relation to the first, motor-side coupling element and the second, gearing-side coupling element. The direction of displacement of the first coupling element, i.e. the motor shaft of the electric motor, in relation to the compensating element is referred to as the first radial direction. The motor shaft can have a coating that optimizes the sliding contact between the motor shaft and the compensating element, e.g. in the form of a sheet metal part pressed thereon, which comes in contact with the compensating element. Likewise, a part attached to the motor shaft that comes in contact with the compensating element can be provided as the first coupling element. Analogously, a contact surface of the compensating element bearing on the first coupling element can also have a coating or lining, which functions as a sliding bearing surface.

In any case, the motor shaft serving as a coupling element may have two flattened parallel sides, which are inserted into a hole in the compensating element in the shape of a slot. The sides can be either entirely flat or curved, wherein if they are curved, the radius of the curvature can lie in a plane, or curvature radii can lie in numerous planes, e.g. in the form of a spherical surface. This results in less friction between the sides and the compensating element than with flat sides.

The slot, which then guides a dihedral section the motor shaft such that the rotational torque is transferred, can be either a blind hole or a through hole. The longitudinal cross section of the slot defines the radial direction in both cases, i.e. the direction of displacement in which the motor shaft can be offset in relation to the compensating element. The guidance of the dihedral in the slot forms a clearance fit.

The sides can be produced by removing material through a cutting process. These sides then do not extend beyond an imaginary cylinder described by the surface of the motor shaft. Alternatively, the sides can also be produced using shaping processes, wherein the end of the motor shaft where the sides are provided for transferring the rotational torque can be wider the rest of the motor shaft.

Independently of whether the flattened end section of the motor shaft guided in a sliding manner in the compensating element—when seen in a cross section—lies entirely inside the cylindrical outer shape of the motor shaft, or is wider than this cylindrical shape, a stop is formed by the motor shaft, preferably acting in the axial direction in relation to the compensating element. As a result, the compensating coupling can be easily installed, and at least slight axial movements between the electric motor and the gearing can be compensated for by means of the compensating coupling. A retaining element acting in the opposing axial direction, i.e. a retaining element that prevents removal of the motor shaft from the compensating element, can be implemented with a retaining ring, for example.

If the compensating element is in the form of a double-winged drive element, its wings lie in a displacement plane orthogonal to the slot, i.e. to the first radial direction, in which the compensating element can be displaced in relation to the second coupling element. The two wings may be thinner in the first radial direction than the maximum diameter of the slot in the same direction. The thickness of the wing is to be measured at the point where it comes in contact with the second coupling element.

The compensating element, which can assume the form of a double-winged drive element, can be efficiently produced using powder metallurgy methods. The compensating element can likewise be produced using cutting or shaping methods.

In one embodiment, the second coupling element is the inner ring of a rolling element bearing, in particular the inner ring of a ball bearing. The second coupling element can likewise be connected in a fixed manner to a ball bearing inner ring or some other inner ring of a rolling element bearing. Such a ball bearing or other rolling element bearing preferably functions as a component of a shaft generator therein. The gearing as a whole is configured as a shaft gearing in this case. An eccentric gearing, planetary gearing or wobble plate gearing can likewise be used as the gearing.

The adjusting device can be used in stationary applications as well as in motor vehicles. By way of example, the adjusting device is configured as an electric camshaft adjuster. The adjusting device can likewise be used in a device for varying the compression ratio in a reciprocating piston engine, in particular an internal combustion piston engine. In this case, an eccentric shaft is adjusted by the gearing of the adjusting device, which interacts with other components of a crankshaft drive via a link rod.

### BRIEF DESCRIPTION OF THE DRAWINGS

An exemplary embodiment of the disclosure shall be explained in greater detail below based on the drawings. Therein:

FIG. 1 shows a section of an adjusting device with a compensating coupling in a perspective view,

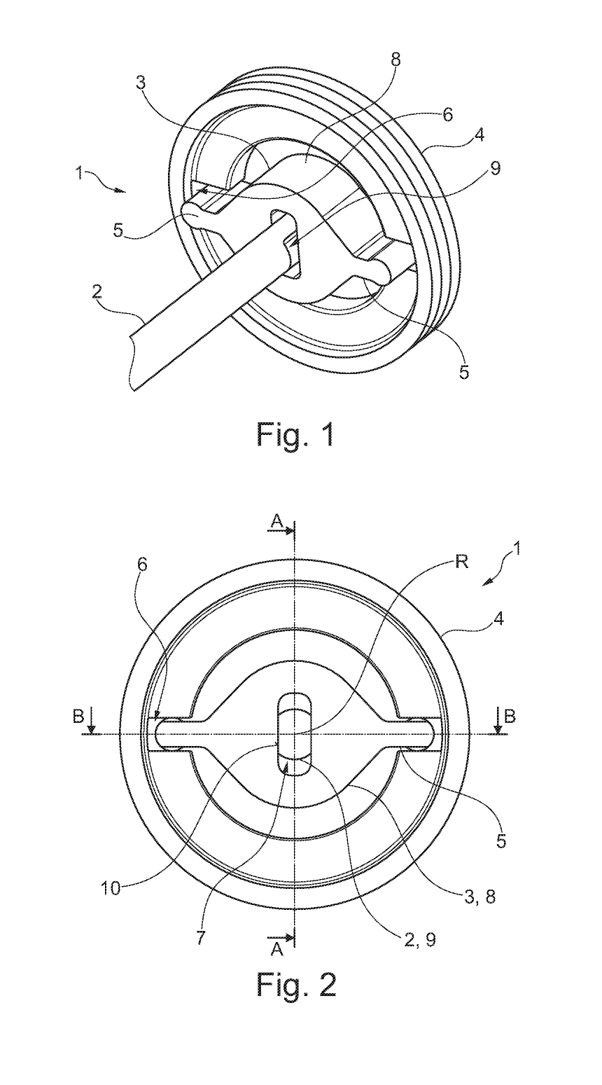

FIGS. 2 to 4 show various cross sections through the assembly according to FIG. 1.

### DETAILED DESCRIPTION

The adjusting device shown in the figures is an electric camshaft adjuster, referred to in the prior art cited in the introduction regarding its principle function. The camshaft adjuster is actuated by an electric motor (not shown), e.g. an electronic commuting synchronous motor, the motor shaft of which is indicated by the numeral 2. The motor shaft 2 is also a first coupling element of a compensating coupling 1 in the form of an Oldham coupling, which couples the electric motor to a gearing, specifically a shaft gearing, of the electric camshaft adjuster while enabling a radial offset.

A bearing ring 4, specifically the inner ring of a rolling element bearing, functions as the second, gearing-side coupling element of the compensating coupling 1 and is a component of a shaft generator, which is part of the gearing in the adjusting device. The bearing ring 4 has an elliptical outer shape, i.e. not circular, wherein rolling elements rolling along a bearing race 11, specifically balls, also come in contact with a flexible outer ring (not shown), which continuously adapts to the non-circular shape of the bearing ring 4 when it rotates.

A double-winged drive element 3 interacts directly with the motor shaft 2, i.e. the first coupling element, and the bearing ring 4, i.e. the second coupling element, which functions as the compensating element of the compensating coupling 1.

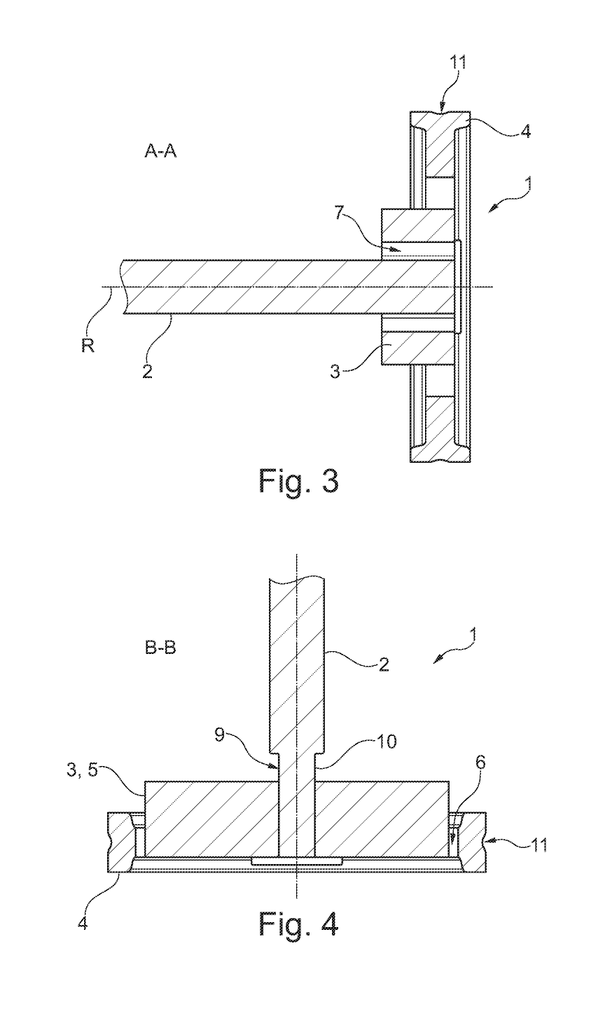

The compensating element 3 is double-winged, wherein two wings are each indicated by the numeral 5, and a middle section of the compensating element 3, which is thicker than the wings 5, is indicated by the numeral 8. The two wings can be displaced to a limited extent in respective gaps 6 in the bearing ring 4, where the plane in which the wings 5 lie is referred to as the displacement plane. The wings 5 are guided in the gaps 6 along linear contact regions, as can be seen in FIG. 2.

A hole in the drive element 3 in the form of a slot 7 is orthogonal to the displacement plane. A flattened section 9 of the motor shaft 2 engages in the hole 7. In a variation of the simplified depiction in FIG. 2, the flattened section 9 can be slightly curved.

The motor shaft 2 is concentric to the bearing ring 4 in the assembly in FIG. 2, wherein the shared rotational axis is indicated by the letter R. The motor shaft 2 bears on the walls of the hole 7 with the sides 10 of the flattened section 9. The motor shaft 2 is retained in the axial direction by a retaining element in the form of a retaining ring, such that it cannot be removed from the compensating coupling 1.

The motor shaft 2 can be displaced to a limited extent within the hole 7 in a defined direction, which is referred to as the first radial direction, and is perpendicular to the displacement plane. On the whole, an axial offset between the motor shaft 2 and the bearing ring 4 can be compensated for in any radial direction by the compensating coupling 1.

### LIST OF REFERENCE SYMBOLS

1 compensating coupling
2 motor shaft, first coupling element
3 compensating element, drive element
4 bearing ring, second coupling element
5 wing
6 gap in bearing ring
7 slot, hole in drive element
8 middle section
9 flattened section
10 side of the flattened section
11 bearing race
R axis of rotation

1. An adjusting device, comprising:
an electric motor that includes a compensating coupling for coupling to gearing, which comprises a first, motor-side coupling element, a second, gearing-side coupling element, and a compensating element that interacts with both coupling elements, wherein a motor shaft of the electric motor functions as the first coupling element.

2. The adjusting device of claim 1, wherein the compensating coupling is configured as an Oldham coupling.

3. The adjusting device of claim 2, wherein the first, motor-side coupling element is configured to be displaced in a first radial direction in relation to the compensating element by two flattened, parallel sides of the motor shaft which are inserted in a hole in the compensating element in a form of a slot.

4. The adjusting device of claim 3, wherein the sides do not extend beyond a cylinder defined by the motor shaft.

5. The adjusting device of claim 3, wherein a stop configured to act in an axial direction with respect to the compensating element is formed by the motor shaft.

6. The adjusting device of claim 3, wherein the compensating element is a double-winged drive element, wherein two wings lie in a displacement plane that is orthogonal to an orientation of the slot, in which the compensating element can be displaced in relation to the second coupling element.

7. The adjusting device of claim 6, wherein the two wings are thinner in the first radial direction than the maximum diameter of the slot measured in the same direction.

8. The adjusting device of claim 7, wherein the second coupling element is an inner ring of a rolling element bearing.

9. (canceled)

10. (canceled)

11. An electric camshaft adjuster, comprising:
an electric motor configured to actuate the camshaft adjuster;
a motor shaft configured to couple the electric motor to a gearing of the electric camshaft adjuster while enabling a radial offset; and
a bearing ring configured as a gearing-side coupling element, wherein the motor shaft is concentric to the bearing ring.

12. The electric camshaft adjuster of claim 11, wherein the motor shaft includes a flattened section that engages with a hole of a compensating element of the camshaft adjuster.

13. The electric camshaft adjuster of claim 11, wherein the motor shaft is retained in an axial direction by a retaining ring.

14. The electric camshaft adjuster of claim 11, wherein the bearing ring has an elliptical outer shape that includes rolling elements configured to roll along a bearing race.

15. The electric camshaft adjuster of claim 11, wherein the electric camshaft adjuster includes a compensating element configured to interact directly with the motor shaft and the bearing ring.

16. The electric camshaft adjuster of claim 15, wherein the compensating element is a double-winged drive element.

17. The electric camshaft adjuster of claim 15, wherein the compensating element includes two wings that are located in respective gaps of the bearing ring.

18. The electric camshaft adjuster of claim 15, wherein the motor shaft is configured to form a stop acting in a axial direction in relation to the compensating element.

19. The electric camshaft adjuster of claim 15, wherein the electric camshaft adjuster includes a retaining element configured to prevent removal of the motor shaft from the compensating element.

20. An apparatus, comprising:
an electric motor that includes a compensating coupling for coupling to gearing, wherein the compensating coupling includes:
a motor shaft configured to couple the electric motor to the gearing of an electric camshaft adjuster while enabling a radial offset;
a second, gearing-side coupling element; and
a compensating element that interacts with the motor shaft and the second, gearing-side coupling element.
